(19) United States
(12) Patent Application Publication
(10) Pub. No.: US 2008/0233411 A1
(43) Pub. Date: Sep. 25, 2008

(54) PREFORM FOR AN ELECTRONIC DEVICE MATERIAL AND METHOD OF FORMING A FUNCTIONAL LAYER

(75) Inventors: Minoru SHINODA, Tokyo (JP); Hirofumi KOBAYASHI, Tokyo (JP); Hirotaka GOMI, Tokyo (JP)

Correspondence Address: GREENBLUM & BERNSTEIN, P.L.C., 1950 ROLAND CLARKE PLACE, RESTON, VA, 20191, US

(73) Assignee: TDK CORPORATION, Tokyo (JP)

(21) Appl. No.: 12/051,270

(22) Filed: Mar. 19, 2008

(30) Foreign Application Priority Data
Mar. 20, 2007 (JP) 2007-072046

(51) Int. Cl. B32B 15/04

(52) U.S. Cl. 428/457; 427/123

(57) ABSTRACT

An electronic device material preform is used when manufacturing an electronic device material where a predetermined functional layer is formed on a surface of a substrate by sputtering. The electronic device material preform includes a discharge-guiding film that conducts electricity and guides abnormal discharge that occurs when the sputtering is carried out. The discharge-guiding film is formed at a predetermined part of an outer circumferential edge of the substrate before the functional layer is formed.

### BACKGROUND OF THE INVENTION

1. Field of the Invention

The present invention relates to a preform for an electronic device material used when manufacturing an electronic device material constructed by forming a predetermined functional layer on the surface of a substrate by sputtering, and a method of forming a functional layer that forms a predetermined functional layer on the surface of a substrate by sputtering.

2. Description of the Related Art

As one method of manufacturing an electronic device material by forming a predetermined functional layer on the surface of a substrate by sputtering, a method of manufacturing a material (“magnetic head material”) for a magnetoresistive thin-film magnetic head (hereinafter simply “method of manufacturing”) is disclosed in Japanese Laid-Open Patent Publication No. H11-329884. In this method of manufacturing, first a conductive film formed of Ti or the like is deposited on the surface of a substrate (an Al₂O₃—TiC substrate) on which an alumina film has been deposited. Next, at a predetermined position inside the sputtering apparatus, the outer circumferential surface and upper surface of the outer edge of the substrate on which various films have been deposited are held by being pressed by a substrate holder that is made of metal and is earthed. Next, a magnetic film is formed on the conductive film by sputtering. Here, even if electric charge due to static electricity is produced in the magnetic film, such electric charge will be discharged on a discharge path composed of the conductive film, the substrate holder, and the earth, thereby preventing the magnetic film from becoming charged. Accordingly, in this method of manufacturing, the production of faults in the magnetic film due to discharge occurring between the substrate holder and the magnetic film due to the magnetic film becoming charged is prevented.

### SUMMARY OF THE INVENTION

However, by investigating the method of manufacturing described above, the present inventors found the following problem. When manufacturing the magnetic head material described above, it is necessary to form a large number of functional layers on a substrate by sputtering. Accordingly, to improve productivity when manufacturing the magnetic head material, it is important to reduce the time required to form one functional layer by sputtering. For this reason, when thick functional layers in particular are formed on a substrate, the applied voltage is set at a higher value to raise the sputtering rate (i.e., the amount of film material that accumulates per unit time) to reduce the processing time of the sputtering. However, when the applied voltage is a high voltage, abnormal discharge (“spark discharge”) can occur on the substrate, resulting in the problem that the substrate can become damaged by the abnormal discharge and that part or all of the substrate will be unusable as a material.

The present invention was conceived in view of the problem described above and it is a principal object of the present invention to provide a preform for an electronic device material and a method of forming a functional layer that have improved productivity and reduce damage when forming a functional layer by sputtering.

To achieve the stated object, an electronic device material preform according to the present invention is an electronic device material preform used when manufacturing an electronic device material where a predetermined functional layer is formed on a surface of a substrate by sputtering, the electronic device material preform including a discharge-guiding film that conducts electricity and guides abnormal discharge that occurs when the sputtering is carried out, the discharge-guiding film being formed at a predetermined part of an outer circumferential edge of the substrate before the functional layer is formed.

A method of forming a functional layer according to the present invention forms a predetermined functional layer by sputtering when manufacturing an electronic device material where the predetermined functional layer is formed on a surface of a substrate, the method including: fabricating a preform by forming a discharge-guiding film, which conducts electricity and guides abnormal discharge that occurs when the sputtering is carried out, at a predetermined part of an outer circumferential edge of the substrate before the functional layer is formed; and forming the predetermined functional layer by carrying out the sputtering on the preform.

According to the above electronic device material preform and method of forming a functional layer for the present invention, by constructing the preform by forming the discharge-guiding film that conducts electricity on the outer edge of the substrate and by forming the predetermined functional layer by sputtering on the preform, it is possible to have the discharge-guiding film that conducts electricity protrude closer to the electrodes of a sputtering apparatus than the surface of the substrate. This means that even if abnormal discharge occurs due to a high setting of the voltage applied to the electrodes, it will be possible to reliably guide such abnormal discharge to the discharge-guiding film. This means that even if the electronic device material is damaged due to abnormal discharge, the damaged part can be restricted to the outer circumferential edge of the substrate that is normally not used. In addition, even if large abnormal discharge occurs and damage is caused to a comparatively large part that includes the periphery of the part where the discharge-guiding film is formed on the electronic device material, the area of the damaged part of the electronic device material in such case can be sufficiently suppressed to a smaller area than the damaged area in a hypothetical case where the center of the electronic device material is damaged due to a similar level of abnormal discharge. Accordingly, according to the preform and the method of forming a functional layer, compared to a construction that is not provided with the discharge-guiding film and a method that uses a preform that is not provided with the discharge-guiding film, it is possible to sufficiently reduce effective damage to the electronic device material. As a result, it is possible to sufficiently suppress the drop in yield due to damage to the electronic device material when manufacturing electronic devices as final products.

Here, as the predetermined part, the discharge-guiding film may be formed at a plurality of belt-shaped positions that are separated from one another at the outer circumferential edge of the substrate. With this construction, it will be possible regardless of where abnormal discharge occurs inside the sputtering apparatus to reliably guide the abnormal discharge to the discharge-guiding film formed at one of such positions.

Also, the discharge-guiding film may be formed of metal. By using this construction, it will be possible to reliably guide the abnormal discharge using the discharge-guiding film.

In the above method of forming a functional layer, the discharge-guiding film may be formed at the predetermined part by forming a cover film of conductive material across the entire surface of the substrate, forming a mask at the predetermined part, and etching and removing a part of the cover film aside from a part shielded by the mask. By forming the functional layer in this way, it is possible to accurately form the discharge-guiding film with an arbitrary size at arbitrary positions on the substrate.

It should be noted that the disclosure of the present invention relates to a content of Japanese Patent Application 2007-072046 that was filed on 20 Mar. 2007 and the entire content of which is herein incorporated by reference.

### BRIEF DESCRIPTION OF THE DRAWINGS

These and other objects and features of the present invention will be explained in more detail below with reference to the attached drawings, wherein:

FIG. 1 is a block diagram showing the construction of an electronic device material manufacturing apparatus;

FIG. 2 is a block diagram showing the construction of a sputtering apparatus;

FIG. 3 is a block diagram showing the construction of a discharge-guiding film forming apparatus;

FIG. 4 is a cross-sectional view of a substrate in a state where a metal layer has been formed;

FIG. 5 is a cross-sectional view of the substrate in a state where a resist layer has been formed;

FIG. 6 is a diagram useful in explaining a state where an exposing process is being carried out;

FIG. 7 is a cross-sectional view of the substrate in a state where a resist pattern has been formed;

FIG. 8 is a diagram useful in explaining a state where an etching process is being carried out;

FIG. 9 is a cross-sectional view showing the overall construction of a preform;

FIG. 10 is a plan view of the preform;

FIG. 11 is a plan view of a substrate holding unit in a state where preforms have been set;

FIG. 12 is a plan view of an electronic device material;

FIG. 13 is a plan view of an electronic device material that has been damaged by abnormal discharge;

FIG. 14 is a plan view of another preform; and

FIG. 15 is a plan view of yet another preform.

### DESCRIPTION OF THE PREFERRED EMBODIMENTS

Preferred embodiments of a preform for an electronic device material and a method of forming a functional layer according to the present invention will now be described with reference to the attached drawings.

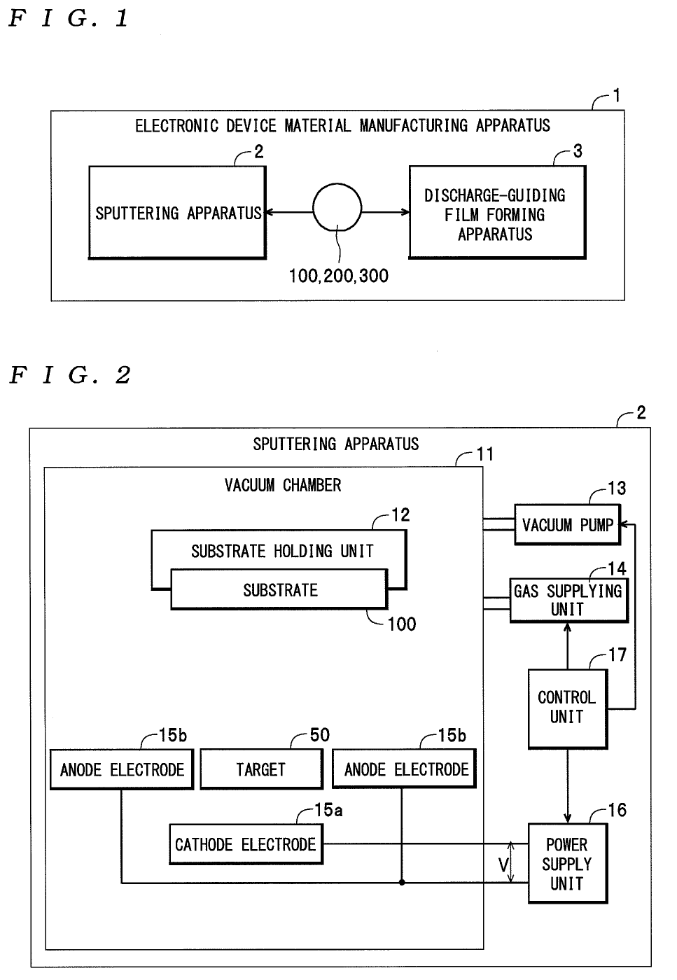

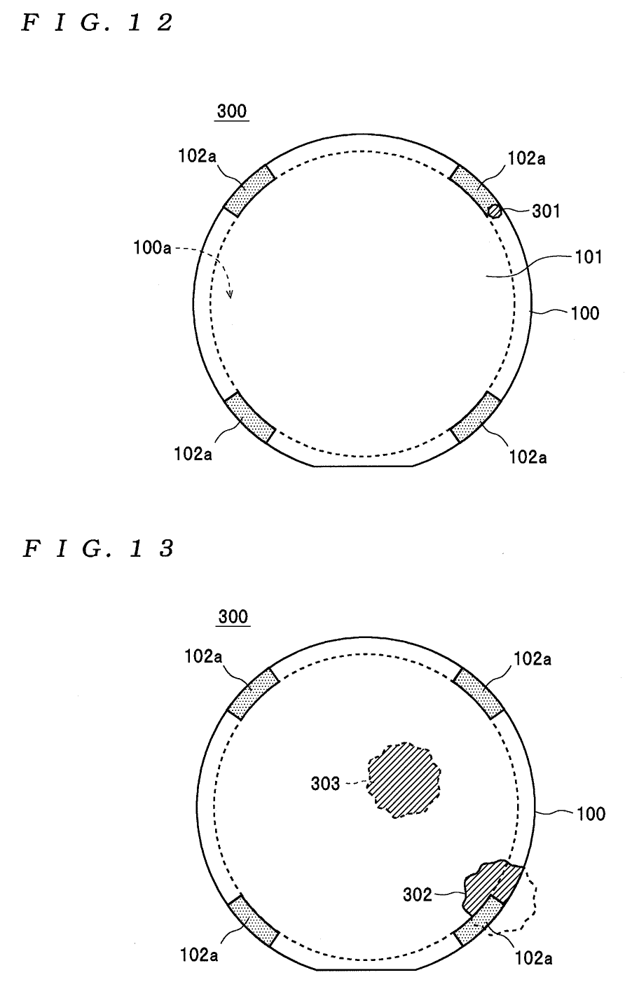

First, the construction of an electronic device material manufacturing apparatus 1 (hereinafter simply “manufacturing apparatus 1”) will be described. The manufacturing apparatus 1 shown in FIG. 1 includes a sputtering apparatus 2 and a discharge-guiding film forming apparatus 3, and is formed so as to be capable of manufacturing an electronic device material 300 (see FIG. 12). Here, the electronic device material 300 is a material for manufacturing a magnetic head (one example of an “electronic device” for the present invention) and by cutting up the electronic device material 300, a plurality of magnetic heads are manufactured.

The sputtering apparatus 2 is an apparatus (as one example, a DC magnetron sputtering apparatus) that forms a functional layer 101 (see FIG. 12) on a surface of a substrate 100 by sputtering. As shown in FIG. 2, the sputtering apparatus 2 includes a vacuum chamber 11, a substrate holding unit 12, a vacuum pump 13, a gas supplying unit 14, a cathode electrode 15a, an anode electrode 15b (hereinafter the cathode electrode 15a and the anode electrode 15b are collectively referred to as the “electrodes 15” when no distinction is required), a power supply unit 16, and a control unit 17.

The vacuum chamber 11 is constructed so as to be capable of housing the substrate holding unit 12, the electrodes 15, and a target 50 that is a material for forming the functional layer 101 and a discharge-guiding film 102a, described later. Here, when forming the discharge-guiding film 102a, Au, which is one example of a “conductive material” for the present invention, is used as the target 50 mentioned above.

As shown in FIG. 11, the substrate holding unit 12 includes a mounting table 12a on which substrates 100 (and preforms 200 described later) can be mounted and fixing members 12b that fix the substrates 100 (or the preforms 200) mounted on the mounting table 12a. In accordance with control by the control unit 17, the vacuum pump 13 evacuates the air from inside the vacuum chamber 11 to maintain a vacuum inside the vacuum chamber 11. Also, in accordance with control by the control unit 17, the gas supplying unit 14 supplies inert gas (as one example, a mixture of Ar and N₂) into the vacuum chamber 11. The cathode electrode 15a and the anode electrode 15b are insulated from one another and are respectively connected to the power supply unit 16. In accordance with control by the control unit 17, the power supply unit 16 applies a voltage V between the electrodes 15. The control unit 17 controls the vacuum pump 13, the gas supplying unit 14, and the power supply unit 16.

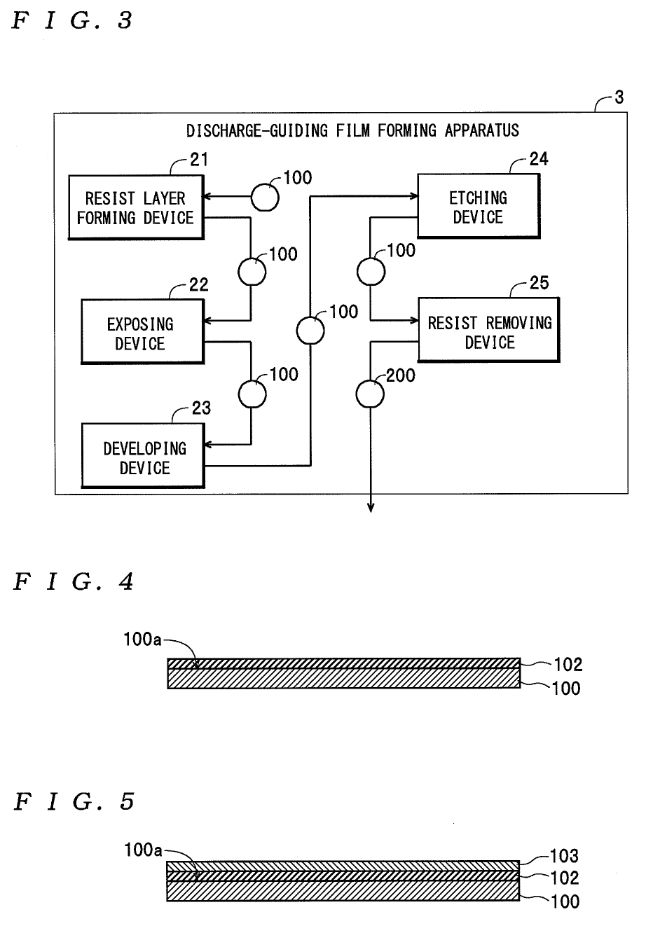

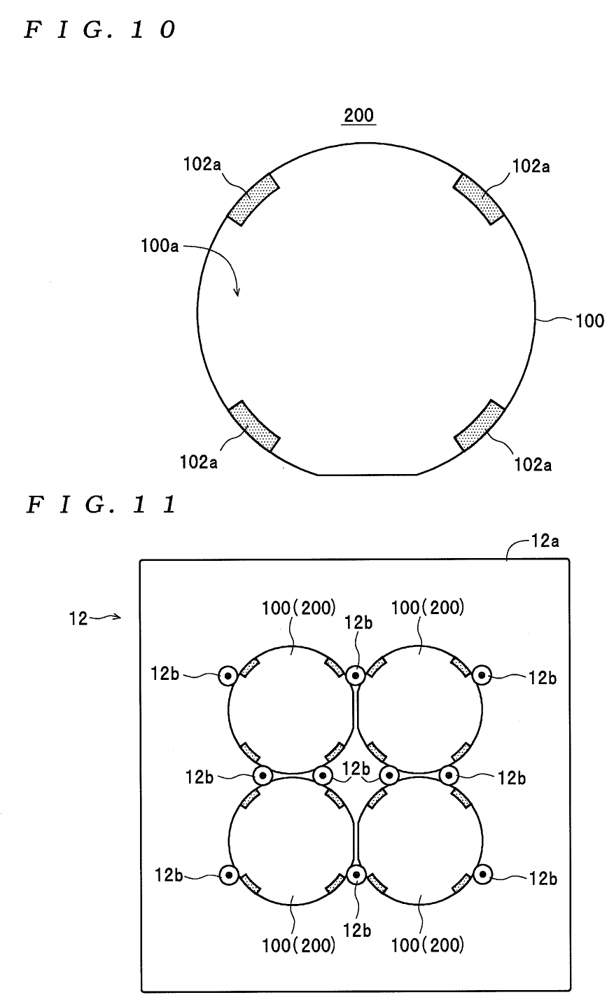

On the other hand, the discharge-guiding film forming apparatus 3 is used when fabricating the preform 200 and as shown in FIG. 3, includes a resist layer forming device 21, an exposing device 22, a developing device 23, an etching device 24, and a resist removing device 25. Here, the preform 200 is a member fabricated during a series of processes for manufacturing the electronic device material 300 by forming various functional layers 101 on a surface 100a of the substrate 100, or in other words is a member used to manufacture the electronic device material 300. As shown in FIG. 10, the discharge-guiding film 102a with a thickness of under 0.1 μm (for example, 0.05 μm) is formed at four arc-shaped belt-shaped positions (that correspond to “a predetermined part” for the present invention) that are separated from each other at the outer circumferential edge of the substrate 100. The discharge-guiding film 102a functions as a discharge point for abnormal discharge that occurs when sputtering is carried out using the sputtering apparatus 2, that is, the discharge-guiding film 102a functions so as to guide the abnormal discharge.

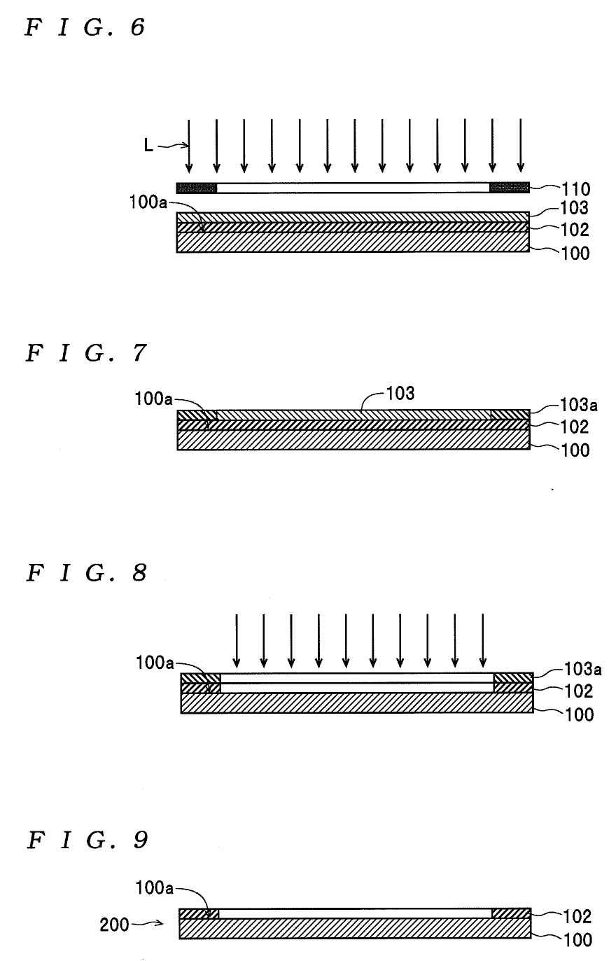

The resist layer forming device 21 applies a resist material onto a metal layer 102 (a “cover film” for the present invention: see FIG. 4) formed on the surface 100a of the substrate 100 by spin coating, for example, to form the resist layer 103 (see FIG. 5). The exposing device 22 emits exposing light L onto the resist layer 103 in a state where a mask 110 (see FIG. 6), which shields parts of the surface 100a of the substrate 100 where the discharge-guiding film 102a will be formed, has been positioned above the substrate 100. By doing so, a latent image is formed inside the resist layer 103 in a shape corresponding to the formation positions of the discharge-guiding film 102a.

The developing device 23 leaves resist material at the parts that were not irradiated with the light L out of the resist layer 103 (i.e. parts where the latent image was formed) and removes resist material at the parts that were irradiated with light L (i.e. parts aside from the parts where the latent image was formed) to form a resist pattern 103a (a “mask” for the present invention: see FIG. 7) on the metal layer 102. The etching device 24 etches the metal layer 102 using the resist pattern 103a formed by the developing device 23 as a mask to remove the metal layer 102 at parts aside from the part shielded from the resist pattern 103a. The resist removing device 25 removes the resist pattern 103a (i.e., the resist material), thereby fabricating the preform 200.

Next, a method of forming the functional layer 101 on the surface 100a of the substrate 100 using the manufacturing apparatus 1 and according to a method of forming a functional layer according to the present invention to manufacture the electronic device material 300 will be described with reference to the drawings. Here, as one example, the substrate 100 is formed in a disc shape using Al₂O₃—TiC and a thin film of aluminum oxide (alumina) that does not conduct electricity is formed in advance on the surface 100a. Note that although the electronic device material 300 is actually constructed by forming a plurality of functional layers 101 on the surface 100a of the substrate 100, for ease of understanding the present invention, an example where a single functional layer 101 is formed on the surface 100a of the substrate 100 will be described.

Before forming the functional layer 101, the discharge-guiding film 102a is formed on the substrate 100 to fabricate the preform 200. More specifically, as shown in FIG. 11, four substrates 100 are mounted on the mounting table 12a of the substrate holding unit 12 in the sputtering apparatus 2. After this, each substrate 100 is fixed using the fixing members 12b. Next, the substrate holding unit 12 to which the substrates 100 have been fixed is set inside the vacuum chamber 11. After this, Au as the target 50 is set on the cathode electrode 15a (near the anode electrode 15b). Next, by operating an operation unit, not shown, sputtering conditions such as the voltage V applied between the electrodes 15, the voltage applying time, and the mixing proportions and flow rate for the inert gas supplied to the vacuum chamber are set, and then an indication to start the sputtering process is given. When doing so, the control unit 17 controls the vacuum pump 13 to evacuate air from inside the vacuum chamber 11 and controls the gas supplying unit 14 to supply inert gas into the vacuum chamber 11 (as one example, the mixed gas Ar:30 sccm+N₂:40 sccm).

Next, the control unit 17 controls the power supply unit 16 to apply the voltage V across the electrodes 15. When doing so, due to the voltage V applied between the electrodes 15, the mixture of Ar and N₂ gas inside the vacuum chamber 11 is ionized (i.e., converted to plasma). As a result, the ionized Ar and N₂ move at high speed inside the vacuum chamber 11 toward the target 50 and collide with the surface of the target 50, so that the Au atoms constructing the target 50 are expelled and accumulate on (i.e., adhere to) the surface of each substrate 100. After this, when a predetermined time has passed, the control unit 17 controls the power supply unit 16 to stop supplying the voltage V. By doing so, as shown in FIG. 4, the metal layer 102 composed of Au is formed on the surface 100a of each substrate 100.

Next, the substrate holding unit 12 is removed from the vacuum chamber 11 and each substrate 100 on which the metal layer 102 has been formed is removed from the substrate holding unit 12. After this, each substrate 100 is set in the resist layer forming device 21 of the discharge-guiding film forming apparatus 3 and the resist layer forming device 21 is operated. When doing so, the resist layer forming device 21 applies a resist material onto the metal layer 102 (i.e., the surface 100a of the substrate 100) as shown in FIG. 5 to form the resist layer 103. Next, each substrate 100 where the resist layer 103 has been formed on the metal layer 102 is set in the exposing device 22 and the exposing device 22 is operated. When doing so, as shown in FIG. 6, the exposing device 22 emits the exposing light L onto the resist layer 103 in a state where the mask 110 is positioned above the substrate 100 to form, inside the resist layer 103, a latent image of a form corresponding to a part where the discharge-guiding film 102a will be formed.

Next, the substrate 100 where the latent image has been formed inside the resist layer 103 is set in the developing device 23 and the developing device 23 is operated. When doing so, the developing device 23 develops the resist layer 103 in which the latent image has been formed to form the resist pattern 103a on the metal layer 102 as shown in FIG. 7. After this, the substrate 100 on which the resist pattern 103a has been formed is set in the etching device 24 and the etching device 24 is operated. When doing so, by etching the metal layer 102 using the resist pattern 103a as a mask, as shown in FIG. 8, the etching device 24 removes the metal layer 102 at parts aside from the part shielded by the resist pattern 103a. Next, the substrate 100 for which etching has been completed is set in the resist removing device 25 and the resist removing device 25 is operated. When doing so, as shown in FIG. 9, the resist removing device 25 removes the resist pattern 103a (i.e., the resist material) remaining on the metal layer 102 to complete the fabricating of the preform 200.

Next, the functional layer 101 is formed on the preform 200. When doing so, as shown in FIG. 11, four preforms 200 are fixed to the substrate holding unit 12, the substrate holding unit 12 is set inside the vacuum chamber 11, and the target 50 used for the functional layer 101 is set inside the vacuum chamber 11. After this, the operation unit is operated to set the sputtering conditions. When a thick functional layer 101 is formed, for example, to reduce the processing time of the sputtering, the voltage V is set high to raise the sputtering rate. Next, the operating unit is operated to designate a start of sputtering. After this, the control unit 17 controls the vacuum pump 13, the gas supplying unit 14, and the power supply unit 16 in the same way as the control described above. When doing so, the ionized mixed gas of Ar and N₂ will move at high speed toward the target 50 and collide with the surface of the target 50 to expel the atoms constructing the target 50. Such atoms then accumulate on the surface of each preform 200 (substrate 100).

This method of forming a functional layer forms the functional layer 101 by sputtering on the preform 200 where the discharge-guiding film 102a, which conducts electricity, has been formed at the outer circumferential edge of the substrate 100. Accordingly, since the discharge-guiding film 102a that conducts electricity protrudes further toward the electrodes 15 than the surface 100a of the substrate 100, even if abnormal discharge occurs due to the voltage V being set high as described above, the discharge-guiding film 102a (and in particular the corners of the discharge-guiding film 102a) will be the discharge point for the abnormal discharge, so that the abnormal discharge is guided to the discharge-guiding film 102a. The outer circumferential edge of the substrate 100 on which the discharge-guiding film 102a has been formed, or in other words, the outer circumferential edge of the electronic device material 300, is normally left unused when manufacturing electronic devices (in this example, magnetic heads). Accordingly, in this method of forming a functional layer, by using the preform 200, as shown in FIG. 12 for example, even when the parts of the electronic device material 300 where the discharge-guiding film 102a is formed become damaged by abnormal discharge (see the damaged part 301 in FIG. 12), it will still be possible to reliably prevent a drop in yield due to such damage when manufacturing electronic devices as the final products.

Also, as shown in FIG. 13, even when a large abnormal discharge occurs and causes damage to a comparatively large part including a periphery of a part of the electronic device material 300 where the discharge-guiding film 102a is formed, the area of the damaged part (see the damaged part 302 in FIG. 13) can be kept much smaller than the damaged area for a hypothetical case where the center of the electronic device material 300 is damaged due to a similar level of abnormal discharge (see the damaged part 303 shown by the dashed line in FIG. 13). Accordingly, with this method of forming a functional layer, by using the preform 200, even if a large abnormal discharge occurs, compared to a construction not provided with the discharge-guiding film 102a, it is possible to sufficiently suppress the drop in yield due to damage to the electronic device material 300 when manufacturing electronic devices as the final products.

Next, when the predetermined time has passed, the control unit 17 controls the power supply unit 16 to stop supplying the voltage V. By doing so, as shown in FIG. 12, the functional layer 101 is formed on the surface 100a of the substrate 100 to complete the electronic device material 300.

In this way, according to the preform 200 and this method of forming the functional layer, by constructing the preform 200 by forming the discharge-guiding film 102a that conducts electricity on the outer circumferential edge of the substrate 100 and by forming the functional layer 101 by sputtering on the preform 200, it is possible to have the discharge-guiding film 102a that conducts electricity protrude closer to the electrodes 15 than the surface 100a of the substrate 100. This means that even if abnormal discharge occurs due to a high setting of the voltage V applied between both electrodes 15, it will be possible to reliably guide such abnormal discharge to the discharge-guiding film 102a. This means that even if the electronic device material 300 is damaged due to abnormal discharge, the damaged part can be restricted to the outer circumferential edge of the substrate 100 that is normally not used. In addition, even if large abnormal discharge occurs and damage is caused to a comparatively large part that includes the periphery of the part where the discharge-guiding film 102a is formed on the electronic device material 300, the area of the damaged part of the electronic device material 300 in such case can be sufficiently suppressed to a smaller area than the damaged area in a hypothetical case where the center of the electronic device material 300 is damaged due to a similar level of abnormal discharge. Accordingly, according to the preform 200 and the method of forming a functional layer, compared to a construction that is not provided with the discharge-guiding film 102a and a method that uses a preform that is not provided with the discharge-guiding film 102a, it is possible to sufficiently reduce effective damage to the electronic device material 300. As a result, it is possible to sufficiently suppress the drop in yield due to damage to the electronic device material 300 when manufacturing electronic devices as the final products.

Also, according to the preform 200 and this method of forming the functional layer, by forming the discharge-guiding film 102a at four belt-shaped positions that are separated from each other around the outer circumferential edge of the substrate 100, it will be possible regardless of where abnormal discharge occurs in the vacuum chamber 11 to reliably guide the abnormal discharge to the discharge-guiding film 102a formed at one of such positions.

Also, according to the preform 200 and this method of forming the functional layer, by forming the discharge-guiding film 102a of metal that has high electrical conductivity, it will be possible to reliably guide the abnormal discharge using the discharge-guiding film 102a.

In addition, according to this method of forming the functional layer, by forming the metal layer 102 across the entire surface 100a of the substrate 100, forming the resist pattern 103a at predetermined positions on the outer circumferential edge of the substrate 100, and forming the discharge-guiding film 102a by etching and removing the metal layer 102 at parts aside from parts shielded by the resist pattern 103a, it is possible to accurately form the discharge-guiding film 102a with an arbitrary size at arbitrary positions on the substrate 100.

Note that the present invention is not limited to the construction described above. For example, although an example where Au is used as the target 50 used for the discharge-guiding film 102a has been described above, the present invention is not limited to this and it is possible to form the discharge-guiding film 102a using various metals with high conductivity such as Ag, Cu, Ni, Fe, Co, and Ti, or using an alloy of such metals. It is also possible to form the discharge-guiding film 102a using a non-metallic conductive material. Also, although an example where the preform 200 is used to manufacture the electronic device material 300 for manufacturing magnetic heads has been described, it is possible to apply the present invention to a preform used to manufacture various types of electronic device materials where a functional layer is formed by sputtering, such as an electronic device material for manufacturing semiconductor devices.

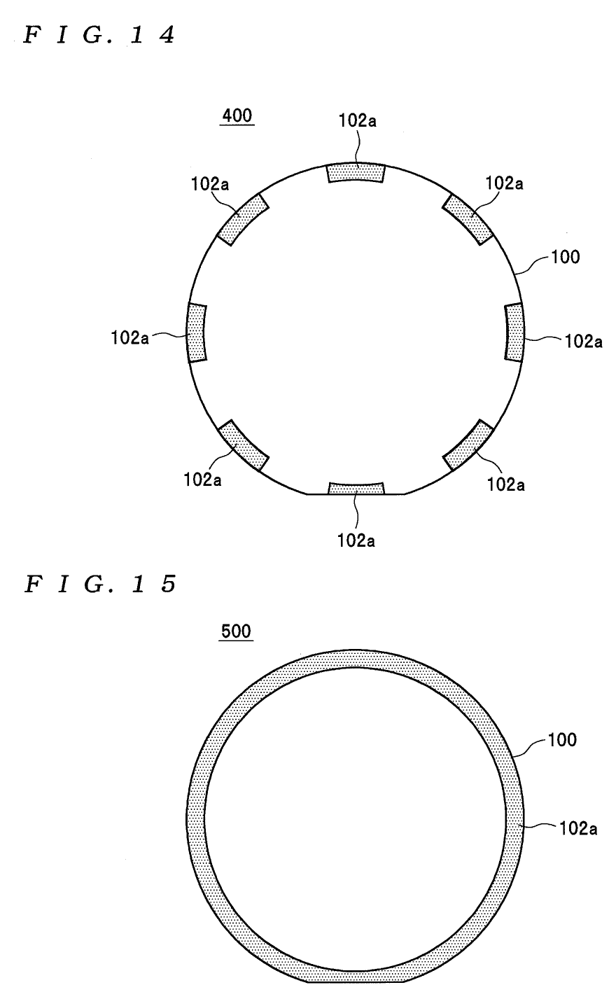

Although the preform 200 where the discharge-guiding film 102a is formed at four belt-shaped positions on the outer circumferential edge of the substrate 100 has been described as an example, the number and shape of the parts where the discharge-guiding film 102a is formed may be set arbitrarily. For example, as shown in FIG. 14, the present invention can be applied to a preform 400 where the discharge-guiding film 102a is formed at eight belt-shaped positions on the outer circumferential edge of the substrate 100. Alternatively, as shown in FIG. 15, the present invention may be applied to a preform 500 where the discharge-guiding film 102a is formed around the entire outer circumferential edge of the substrate 100, or in other words, at a ring-shaped part at the outer circumferential edge.

What is claimed is:

1. An electronic device material preform used when manufacturing an electronic device material where a predetermined functional layer is formed on a surface of a substrate by sputtering,
the electronic device material preform comprising a discharge-guiding film that conducts electricity and guides abnormal discharge that occurs when the sputtering is carried out, the discharge-guiding film being formed at a predetermined part of an outer circumferential edge of the substrate before the functional layer is formed.

2. An electronic device material preform according to claim 1,
wherein as the predetermined part, the discharge-guiding film is formed at a plurality of belt-shaped positions that are separated from one another at the outer circumferential edge of the substrate.

3. An electronic device material preform according to claim 1,
wherein the discharge-guiding film is formed of metal.

4. An electronic device material preform according to claim 2,
wherein the discharge-guiding film is formed of metal.

5. A method of forming a functional layer that forms a predetermined functional layer by sputtering when manufacturing an electronic device material where the predetermined functional layer is formed on a surface of a substrate,
the method comprising:
fabricating a preform by forming a discharge-guiding film, which conducts electricity and guides abnormal discharge that occurs when the sputtering is carried out, at a predetermined part of an outer circumferential edge of the substrate before the functional layer is formed; and
forming the predetermined functional layer by carrying out the sputtering on the preform.

6. A method of forming a functional layer according to claim 5,
wherein the discharge-guiding film is formed at the predetermined part by forming a cover film of conductive material across the entire surface of the substrate, forming a mask at the predetermined part, and etching and removing a part of the cover film aside from a part shielded by the mask.
